(19) United States
(12) Patent Application Publication
(10) Pub. No.: US 2026/0077573 A1
(43) Pub. Date: Mar. 19, 2026

(54) INTERLAYER HAVING IMPROVED LAMINATION PROCESSABILITY

(71) Applicant: Solutia Inc., St. Louis, MO (US)

(72) Inventor: Wenjie Chen, Amherst, MA (US)

(73) Assignee: Solutia Inc., St. Louis, MO (US)

(21) Appl. No.: 18/873,768

(22) PCT Filed: Jun. 20, 2023
(86) PCT No.: PCT/US2023/068691

§ 371 Date: Dec. 11, 2024

Related U.S. Application Data
(60) Provisional application No. 63/366,703, filed on Jun. 21, 2022.

(51) Int. Cl. B32B 17/10; B60J 1/00

(52) U.S. Cl. CPC B32B 17/10761; B32B 17/10036; B32B 17/10651; B32B 17/10935; B60J 1/001; B32B 2307/308; B32B 2307/402; B32B 2605/00

(57) ABSTRACT

Interlayers having improved lamination processability while also having excellent sound or acoustic properties are disclosed. The interlayers have a warm shrinkage of less than about 4%, a static coefficient of friction (COF) of less than 1.50 when measured according to ASTM D1894 with an interlayer to interlayer configuration, and wherein the laminated glazing has a damping loss factor (η) of at least 0.20 when measured at 20° C. according to ISO 16940.

### FIELD OF THE INVENTION

This disclosure is related to the field of polymer interlayers for multiple layer glass panels and multiple layer glass panels having at least one polymer interlayer sheet. Specifically, this disclosure is related to the field of multiple layer panels comprising polymer interlayers comprising multiple thermoplastic layers which have improved acoustic properties such as improved damping and improved processability and handling. This disclosure is also related to an improved process for assembling the laminated glazing using the enhanced interlayers of the invention.

### DESCRIPTION OF RELATED ART

Multiple layer panels are generally panels comprised of two sheets of a substrate (such as, but not limited to, glass, polyester, polyacrylate, or polycarbonate) with one or more polymer interlayers sandwiched therebetween. The laminated multiple layer glass panels are commonly utilized in architectural window applications and in the windows of motor vehicles and airplanes, and in photovoltaic solar panels. The first two applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces. Additionally, the interlayer may also give the glass a much higher sound insulation rating, reduce UV and/or IR light transmission, and enhance the aesthetic appeal of the associated window. In regard to the photovoltaic applications, the main function of the interlayer is to encapsulate the photovoltaic solar panels which are used to generate and supply electricity in commercial and residential applications.

In order to achieve the certain property and performance characteristics for the glass panel, it has become common practice to utilize multiple layer or multilayered interlayers. As used herein, the terms “multilayer” and “multiple layers” mean an interlayer having more than one layer, and multilayer and multiple layer may be used interchangeably. Multiple layer interlayers typically contain at least one soft layer and at least one stiff layer. Interlayers with one soft “core” layer sandwiched between two more rigid or stiff “skin” layers have been designed with sound insulation properties for the glass panel. Interlayers having the reverse configuration, that is, with one stiff layer sandwiched between two more soft layers have been found to improve the impact performance of the glass panel and can also be designed for sound insulation. Examples of multiple layer interlayers also include the interlayers with at least one “clear” or non-colored layer and at least one colored layer or at least one conventional layer, e.g., non-acoustic layer, and at least one acoustic layer (i.e., a layer have acoustic properties or the ability to provide sound insulation or reduce sound transmission, as further defined below). Other examples of multiple layer interlayers include interlayers with at least two layers with different colors for aesthetic appeal. The colored layer typically contains pigments or dyes or some combination of pigments and dyes.

The layers of the interlayer are generally produced by mixing a polymer resin such as poly(vinyl butyral) with one or more plasticizers and melt processing the mix into a sheet by any applicable process or method known to one of skill in the art, including, but not limited to, extrusion. Multiple layer interlayers can be produced by processes such as co-extrusion or lamination wherein the layers are combined together to form a unitary structure. Other additional ingredients may optionally be added for various other purposes. After the interlayer sheet is formed, it is typically collected and rolled for transportation and storage and for later use in the multiple layer glass panel, as discussed below.

The following offers a simplified description of the manner in which multiple layer glass panels are generally produced in combination with the interlayers. First, at least one polymer interlayer sheet (single or multilayer) is placed between two substrates and any excess interlayer is trimmed from the edges, creating an assembly. It is not uncommon for multiple polymer interlayer sheets or a polymer interlayer sheet with multiple layers (or a combination of both) to be placed within the two substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high temperature and pressure lamination process, or any other method known to one of ordinary skill in the art such as, but not limited to, autoclaving.

Multilayer interlayers such as a trilayer interlayer having a soft core layer and two stiffer skin layers are commercially available. The stiff skin layers provide handling, processing and mechanical strength of the interlayer; the soft core layer provides acoustic damping properties.

Vibration damping properties of the laminated glass for vehicle glazing applications, such as windshield, side laminates, and sunroof are essential for a vehicle's cabin noise level, since the vehicle glazing occupy a large portion of the vehicle cabin area and are the major path for the external noises (such as wind noise, road noise, tire noise, engine noise) entering the vehicle cabin. Having a high vibration damping laminated glass glazing would allow more external noise or sound to be absorbed, keeping the cabin quieter. These high damping laminates can absorb more external noise when used for automobile glazing.

There is a need to maximize the laminate's damping and meanwhile meet the industrial safety requirement for the vehicle glazing application. The current invention discloses interlayers providing a high damping loss factor while improving the efficiency for producing a glass laminate as well as meeting the industrial requirements for the vehicle glazings. The current invention also provides a process for handling the interlayer more efficiently to meet the ever-demanding lamination processability requirements, especially in the robotic lamination assembly process.

Summarized, it is now common to use a multilayer interlayer in order to provide high performance laminates. There is a need in the art for the development of a multilayered interlayer that has good optical, mechanical, and acoustic characteristics desirable in a multilayered interlayer. More specifically, there is a need in the art for the development of multilayered interlayers having good acoustic properties such as damping loss factor that can also be used and process more efficiently.

### SUMMARY OF THE INVENTION

Because of these and other problems in the art, described herein, among other things are a polymer interlayer, wherein the polymer interlayer has a warm shrinkage of less than about 4.0% (3.9%, 3.8%, 3.7%, 3.6%, 3.5%, 3.4%, 3.3%, 3.2%, 3.1%, 3.0%, 2.9%, 2.8%, 2.7%, 2.6%, 2.5%, 2.4%, 2.3%, 2.2%, 2.1%, 2.0% or less), a static coefficient of friction (COF) of less than 1.50 (1.45, 1.40, 1.35, 1.30, 1.25, 1.20, 1.15, 1.10, 1.05, 1.00, 0.95, 0.90, 0.85, 0.80, 0.75, 0.70, 0.65, 0.60, 0.55, 0.50, 0.45, 0.40, 0.35, 0.30 or less) when measured according to ASTM D1894 with the interlayer to interlayer configuration and wherein a multilayer glass panel comprising the interlayer has a damping loss factor (η) of at least 0.20 (0.21, 0.22, 0.23, 0.24, 0.25, 0.26, 0.27, 0.28, 0.29, 0.30 or more) when measured at 20° C. according to ISO 16940. In embodiments, the interlayer has a static coefficient of friction (COF) of less than 2.00 (1.95, 1.90, 1.85, 1.80, 1.75, 1.70, 1.65, 1.60, 1.55, 1.50, 1.45, 1.40, 1.35, 1.30, 1.25, 1.20, 1.15, 1.10, 1.05, 1.00, 0.95, 0.90, 0.85, 0.80, 0.75, 0.70, 0.65, 0.60, 0.55, 0.50, 0.45 or less) when measured according to ASTM D1894 with the interlayer to the metal sled configuration. In embodiments, the interlayer has a dynamic coefficient of friction (COF) of less than 0.50 (0.45, 0.40, 0.35, 0.30 or less) when measured according to ASTM D1894 with the interlayer to the interlayer configuration. In embodiments, the interlayer has a dynamic coefficient of friction (COF) of less than 1.00 (0.95, 0.90, 0.85, 0.80, 0.75, 0.70) when measured according to ASTM D1894 with the interlayer to the metal sled configuration.

In embodiments, the interlayer is a multilayer interlayer comprising: a first layer comprising a first poly(vinyl acetal) resin having a first residual hydroxyl content and a first residual acetate content, and a first plasticizer, wherein the first layer has a glass transition temperature (T_{g}) greater than 37° C.; a second layer comprising a second poly(vinyl acetal) resin having a second residual hydroxyl content, and a second plasticizer, wherein the second layer has a glass transition temperature (T_{g}) less than 20° C.; and a third layer comprising a third poly(vinyl acetal) resin having a third residual hydroxyl content, and a third plasticizer, wherein the third layer has a glass transition temperature (T_{g}) greater than 37° C., wherein the second layer is between the first layer and the third layer.

In an embodiment, a laminate comprises: a first glass substrate; a polymer interlayer; and a second rigid substrate; wherein the polymer interlayer has a warm shrinkage of less than about 4.0% (3.9%, 3.8%, 3.7%, 3.6%, 3.5%, 3.4%, 3.3%, 3.2%, 3.1%, 3.0%, 2.9%, 2.8%, 2.7%, 2.6%, 2.5%, 2.4%, 2.3%, 2.2%, 2.1%, 2.0% or less), a static coefficient of friction (COF) of less than 1.50 (1.45, 1.40, 1.35, 1.30, 1.25, 1.20, 1.15, 1.10, 1.05, 1.00, 0.95, 0.90, 0.85, 0.80, 0.75, 0.70, 0.65, 0.60, 0.55, 0.50, 0.45, 0.40, 0.35, 0.30 or less) when measured according to ASTM D1894 with the interlayer to interlayer configuration and wherein a multilayer glass panel comprising the interlayer has a damping loss factor (η) of at least 0.20 (0.21, 0.22, 0.23, 0.24, 0.25, 0.26, 0.27, 0.28, 0.29, 0.30 or more) when measured at 20° C. according to ISO 16940. In embodiments, the interlayer has a static coefficient of friction (COF) of less than 2.00 (1.95, 1.90, 1.85, 1.80, 1.75, 1.70, 1.65, 1.60, 1.55, 1.50, 1.45, 1.40, 1.35, 1.30, 1.25, 1.20, 1.15, 1.10, 1.05, 1.00, 0.95, 0.90, 0.85, 0.80, 0.75, 0.70, 0.65, 0.60, 0.55, 0.50, 0.45 or less) when measured according to ASTM D1894 with the interlayer to the metal sled configuration. In embodiments, the interlayer has a dynamic coefficient of friction (COF) of less than 0.50 (0.45, 0.40, 0.35, 0.30 or less) when measured according to ASTM D1894 with the interlayer to the interlayer configuration. In embodiments, the interlayer has a dynamic coefficient of friction (COF) of less than 1.00 (0.95, 0.90, 0.85, 0.80, 0.75, 0.70) when measured according to ASTM D1894 with the interlayer to the metal sled configuration.

In embodiments, the first poly(vinyl acetal) resin and the third poly(vinyl acetal) resin are the same. In embodiments, the first and third plasticizers are the same. In other embodiments, the second plasticizer is the same as at least one of the first plasticizer or the third plasticizer.

In embodiments, the difference between the first residual hydroxyl content and the second residual hydroxyl content is at least 2.0 (2.5, 3.0, 3.5, 4.0, 4.5, 5.0, 5.5, 6.0 or more) weight percent. In embodiments, the difference between the first residual acetate content and the second residual acetate content is at least 2.0 (2.5, 3.0, 3.5, 4.0, 4.5, 5.0, 5.5, 6.0 or more) weight percent.

In embodiments, the interlayer is a colored interlayer. In embodiments, the colored interlayer has a percent transmittance (% T) of less than about 75% (70%, 65%, 60%, 55%, 50%, 45%, 40%, 35%, 30%, 25%, 20%, 15%, 10%, 5%, 4%, 3%, 2% or less). % T is also referred to as luminous transmittance % T and is measured according to ASTM D1003-13 Procedure B using Illuminant C, at an observer angle of 2 degrees. In embodiments, the colored interlayer is grey, such as a light grey or dark grey interlayer sheet.

In embodiments, the interlayer comprises an IR absorber. In embodiments, the interlayer is a multilayer interlayer having an IR absorber in at least one layer.

In embodiments, the interlayer further comprises a non-poly(vinyl acetal) layer. In embodiments, the interlayer comprises a non-poly(vinyl acetal) layer that is a functional film, layer or sheet(s) such as a polyethylene terephthalate (PET) film, a coated PET film, or other layer such as an IR absorbing or IR reflecting film.

A method of making a polymer interlayer is also disclosed, wherein the polymer interlayer is as disclosed herein.

In embodiments, a process for making a laminate is disclosed, the process comprising the steps of: providing a first rigid substrate to an assembly fixture, providing an interlayer blank, placing the interlayer blank on the first rigid substrate using a transport device, providing a second rigid substrate and placing the second rigid substrate on the interlayer blank, thereby forming a pre-assembly.

In embodiments, the laminated glazing is a windshield, side lite, sunroof or other window in a vehicle. In embodiments, the laminated glazing is used in a head-up display application.

In certain embodiments, the rigid substrate (or substrates) is glass.

### DESCRIPTION OF THE PREFERRED EMBODIMENT(S)

Described herein, among other things, are laminated glazings comprised of a first and second rigid substrate and a multiple layer polymer interlayer. The interlayers, and therefore the laminated glazings of present disclosure have improved acoustic or sound insulation properties as measured by damping loss factor. Laminated glazings comprising the interlayers of the present invention have a damping loss factor (η) of at least 0.20 (0.21, 0.22, 0.23, 0.24, 0.25, 0.26, 0.27, 0.28, 0.29, 0.30 or more) when measured according to ISO 16940. The interlayers of the present invention also have a static coefficient of friction (measured interlayer to interlayer according to ASTM D1894) of less than 1.50.

Also described is an automated process for making a multiple layer glass panel, such as a side lite, sunroof or windshield. The process includes the steps of: providing a first rigid substrate to an assembly fixture, providing an interlayer blank, placing the interlayer blank on the first rigid substrate using a transport device, providing a second rigid substrate and placing the second rigid substrate on the interlayer blank, thereby forming a pre-assembly. The pre-assembly may be located on a conveyor or other means to move the pre-assembly for further processing. In embodiments, the first and/or second rigid substrates may be provided using a transport device that is the same as or similar to the transport device used for providing the interlayer blank. In embodiments, the pre-assembly is further processed by moving the pre-assembly to a de-air process, such as nip roll, vacuum bag, vacuum ring or other process. After de-airing, the pre-assembly may be further processed, such as in an autoclave.

As used herein, a “transport device” is any device or means for moving or transporting an item automatically (or partially or semi-automatically), such as an interlayer blank or a rigid substrate. The transport device moves the item automatically (such as through the use of controls or programming) and without the use of human hands to physically pick up and carry or move the item and place it another location. Transport devices are known in the art. In embodiments, the transport device is a robot or robotic arm. In embodiments, the transport device may have a suction cup or other means for picking up the rigid substrate and/or interlayer blank.

Also described are multiple layer glass panels comprising the interlayers. The interlayers of the present invention can be used in multiple layer glass panel applications, such as safety glass in windshields, side windows, sunroofs, and roof and architectural windows, among other applications.

In the robotic lamination assembly process, typically the bottom glass sheet (or lite) is picked up by a transport device (such as a robotic arm) with suction cups and placed on an assembly fixture for making the laminate glazing (such as a side laminate), the interlayer is cut to size to form an interlayer blank from the roll, and the interlayer blank is picked up by another transport device and laid up directly onto the bottom glass sheet, and then the top glass sheet is picked up and placed on top of the interlayer blank by the transport device to form a pre-assembly. The pre-assembly is moved, such as on a conveyor, to the deair section to complete the deair process to form a completed assembly, and the completed assembly is then autoclaved to produce the final laminated glass. The interlayer blanks may be cut from a roll and immediately used (such as picked up and transported), or the roll may be cut into interlayer blanks of an appropriate size and stacked on one another (to form a stack of interlayer blanks) for use later in the process. This type of automated assembly process provides the following benefits: reduced labor cost, increased capacity, reduced yield loss due to fewer off-grade or rejected parts caused by human process errors, less propensity for contamination (due to handling, and the like), and less need for advanced scheduling of workers to manually assemble the glazing. Other benefits may be recognized by those of skill in the art.

However, there are at least two issues when using conventional interlayers that could jeopardize the automated process and reduce the productivity: the transport device (i.e., robotic arm) fails to pick up the interlayer due to the softness of the interlayer and/or the stickiness to the adjacent other layer or surface (either to another interlayer blank or to the surface that the blanks are on); the interlayer shrinks too much in the deair process when it is exposed to heat which leads to formation of edge defects such as short interlayer along the edges and bubbles in the final laminated glass.

This shrinkage may be caused or worsened by processing conditions, and may be minimized, for example, by avoiding undue stretching during manufacture, conveyance, and rolling, or pre-relaxing the sheet prior to winding. In addition, the sheet may be again relaxed just prior to use.

Currently, to address the shrinkage issue, laminators must go through additional processing steps. One such extra step includes pre-cutting the interlayer blanks larger than the size of the glass and letting the interlayer blanks relax for 24 to 48 hours before the assembly process. By pre-cutting the interlayer blanks, this increases the amount of sheet handling steps, turn-around time, waste of interlayer (yield loss), and limits the production capacity. For the stickiness of the interlayer (i.e., the propensity of the interlayer to stick to itself or other surfaces, such a worktable), laminators must adjust the process conditions such as room temperature, apply manual intervention, or other process modifications to avoid the operational failure of the transport device.

These and other benefits can be realized with the multilayer interlayer of the present invention which has reduced shrinkage, lower COF and high acoustic damping properties.

Each layer of the multilayered polymer interlayer can be made by mixing one or more polymer resins such as poly(vinyl acetal) resin (such as PVB) and one or more plasticizers. The multilayer interlayer generally contains two or more layers and two or more resins of different compositions. For example, poly(vinyl acetal) resins, such as PVB resins, of different residual hydroxyl contents and/or residual acetate contents are suitable for the layers of the multilayered interlayer compositions. In multilayer comprising two layers, at least one of the two layers is a soft layer and the other layer is a stiff layer. As used herein, a “soft layer” or “softer layer” is the layer having a glass transition temperature less than about 20° C. As used herein, a “stiff layer” or “stiffer layer” generally refers to a layer that is stiffer or more rigid than another layer and that has a glass transition temperature that is generally at least two degrees C. (2° C.) higher than another layer (such as the softer layer).

The multilayer interlayers formed from the compositions may contain two or more glass transitions, and the lowest glass transition occurs at less than 20° C., or less than 15° C., or less than 10° C., or less than 5° C., or less than 0° C., or less than −5° C., or less than −10° C.

Conventional multilayer interlayers such as a trilayer acoustic interlayer contain a soft core layer consisting of a single poly(vinyl butyral) (“PVB”) resin having a low residual hydroxyl content and a high amount of a conventional plasticizer, and two stiff skin layers having significantly higher residual hydroxyl content (see, for example U.S. Pat. Nos. 5,340,654, 5,190,826, and 7,510,771). The residual hydroxyl content in the PVB core resin and the amount of the plasticizer are optimized such that the interlayer provides optimal sound insulation properties under ambient conditions for multiple layer glass panels such as windshields and windows installed in vehicles and buildings.

Multilayer acoustic interlayers such as a trilayer can be designed and produced by: (1) selecting a plasticizer or a mixture of plasticizers, (2) selecting resin(s) for the skin layer(s) and the core layer(s), (3) maintaining plasticizer equilibrium between the core layer(s) and the skin layer(s) (such as by selecting resins having particular properties), and (4) combining the core layer(s) and skin layer(s) to form multilayer interlayers by applicable processes such as co-extrusion or lamination. When the resins and plasticizers are appropriately selected for the desired properties and characteristics, the resultant multilayer acoustic interlayer provides excellent clarity and sound insulation properties without sacrificing other favorable and desired characteristics of conventional multilayered interlayers, for example, optical properties, and mechanical strength of the glass panels made with the multilayered acoustic interlayer.

Some terminology as well as common components found in an interlayer, both generally and in interlayers of the present disclosure, and the formation thereof, will be discussed. The terms “polymer interlayer sheet,” “interlayer,” and “polymer melt sheet” as used herein, generally may designate a single-layer sheet or a multilayered interlayer. A “single-layer sheet,” as the name implies, is a single polymer layer extruded as one layer. A multilayered interlayer, on the other hand, may comprise multiple layers, including separately extruded layers, co-extruded layers, or any combination of separately and co-extruded layers. Thus the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of a single-layer sheet and a plural-layer sheet; and a combination of at least one plural-layer sheet and at least one co-extruded sheet. In various embodiments of the present disclosure, a multilayered interlayer comprises at least two polymer layers (e.g., a single layer or multiple layers co-extruded and/or laminated together) disposed in direct contact with each other, wherein each layer comprises a polymer resin, as detailed more fully below. As used herein for multilayer interlayers having at least three layers, “skin layer” generally refers to the outer layers of the interlayer and “core layer” generally refers to the inner layer(s). Thus, one exemplary embodiment would be: skin layer//core layer//skin layer. In the multilayer interlayers having skin layer//core layer//skin layer configuration, in some embodiments the skin layer maybe stiffer and the core layer may be softer, while in other embodiments the skin layer may be softer and the core layer may be stiffer.

The poly(vinyl acetal) resin is produced by known acetalization processes by reacting polyvinyl alcohol (“PVOH”) with one or more aldehydes such as butyraldehyde in the presence of an acid catalyst, separation, stabilization, and drying of the resin. Such acetalization processes are disclosed, for example, in U.S. Pat. Nos. 2,282,057 and 2,282,026 and Wade, B. 2016, Vinyl Acetal Polymers, Encyclopedia of Polymer Science and Technology. 1-22 (online, copyright 2016 John Wiley & Sons, Inc.), the entire disclosures of which are incorporated herein by reference. The resin is commercially available in various forms, for example, as Butvar® Resin from Solutia Inc., a wholly owned subsidiary of Eastman Chemical Company.

As used herein, residual hydroxyl content (calculated as % vinyl alcohol or % PVOH by weight) in poly(vinyl acetal) resin refers to the amount of hydroxyl groups remaining on the polymer chains after processing is complete. For example, PVB can be manufactured by hydrolyzing poly(vinyl acetate) to poly(vinyl alcohol (PVOH), and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished PVB resin, there typically will be residual acetate groups (as vinyl acetate groups) and residual hydroxyl groups (as vinyl hydroxyl groups) as side groups on the polymer chain. As used herein, residual acetate content (calculated as % vinyl acetate content or poly(vinyl acetate) (PVAc) by weight in poly(vinyl acetal) refers to the amount of residual groups remaining on the polymer chains. As used herein, residual hydroxyl content and residual acetate content is measured on a weight percent (wt. %) basis per ASTM D1396.

In embodiments, when multilayer interlayer of the present invention is a trilayer, the core layer is the soft layer and the skin layers are the stiff layers. In other embodiments, the core layer is stiff and the skin layers are softer. Other combinations and numbers of layers are also possible.

In various embodiments, where the interlayer is a multilayer interlayer such as a trilayer, the soft (or core) layer comprises a poly(vinyl acetal) resin (or the first resin) comprising about 7 to about 16 weight percent (wt. %) hydroxyl groups calculated as % PVOH, about 7 to about 14 wt. %, about 9 to about 14 wt. %, about 8.5 to about 12 wt. %, and for certain embodiments, about 11 to about 13 wt. % hydroxyl groups calculated as % PVOH, although other amounts are also possible.

In various embodiments, where the interlayer is a multilayer interlayer such as a trilayer, the stiff (or skin) layer(s) comprises a poly(vinyl acetal) resin having a residual hydroxyl of at least 2 wt. %, or at least 3, 4, 5, 6, 7, 8, 9, 10, 11, 12, 13, 14, 15, 16, 17, 18, 19 or 20 wt. % or more greater than the residual hydroxyl content of the resin in the soft (or core) layer, and the resin in the skin layer can comprise about 15 to about 35 wt. %, about 15 to about 30 wt. %, or about 17 to about 22 wt. %; and, for certain embodiments, about 22 to about 25 wt. % residual hydroxyl groups calculated as % PVOH, although other amounts are also possible depending on the desired properties.

In either the soft (core) or the stiffer (skin) layer(s) or both, any of the resins can also comprise less than 30 wt. % residual acetate groups, less than 25 wt. % residual acetate groups, less than 20 wt. %, less than 15 wt. %, less than 13 wt. %, less than 10 wt. %, less than 7 wt. %, less than 5 wt. %, or less than 1 wt. %, or less than 0.5 wt. % residual acetate groups calculated as poly(vinyl acetate), or in the range of from 0 to 30 wt. %, 1 to 30 wt. %, 2 to 25 wt. %, 5 to 20 wt. %, or 7 to 15 wt. % residual acetate groups, with the balance being an acetal, such as butyraldehyde (which includes isobutyraldehyde acetal groups), but optionally another acetal group, such as a 2-ethyl hexanal acetal group, or a mix of butyraldehyde acetal and 2-ethyl hexanal acetal groups. In embodiments, any of the resins may comprise a poly(vinyl acetal) resin having a residual acetate content of at least 2 wt. %, or at least 3, 4, 5, 6, 7, 8, 9, 10, 11, 12, 13, 14, 15, 16, 17, 18, 19 or 20 wt. % or more greater than the residual acetate content of another resin in the same or different layer.

The difference in residual hydroxyl and/or residual acetate levels between the poly(vinyl acetal) resins is calculated by subtracting the residual hydroxyl content of the resin with the lower residual hydroxyl content from the residual hydroxyl content of the resin with the greater residual hydroxyl content. As used herein, the term “weight percent different” or “the difference . . . is at least . . . weight percent” refers to a difference between two given weight percentages, calculated by subtracting the one number from the other. For example, a poly(vinyl acetal) resin having a residual hydroxyl content of 12 weight percent has a residual hydroxyl content that is 2 weight percent lower than a poly(vinyl acetal) resin having a residual hydroxyl content of 14 weight percent (14 weight percent-12 weight percent=2 weight percent). As used herein, the term “different” can refer to a value that is higher than or lower than another value. One or more other poly(vinyl acetal) layers may also be present in the interlayer and can have a residual hydroxyl within the ranges provided above.

Additionally, the residual hydroxyl content of the one or more other poly(vinyl acetal) resins can be the same as or different than the residual hydroxyl content of the first and/or second poly(vinyl acetal) resins. Additional poly(vinyl acetal) layers present in the interlayer can have a residual acetate content the same as or different from the residual acetate content of the first and/or second poly(vinyl acetal) resin.

The poly(vinyl acetal) resin such as poly(vinyl butyral) (PVB) resin (or resins) of the present disclosure typically has a molecular weight of greater than 50,000 Daltons, or less than 500,000 Daltons, or about 50,000 to about 500,000 Daltons, or about 70,000 to about 500,000 Daltons, or about 100,000 to about 425,000 Daltons, as measured by size exclusion chromatography using a low angle laser light scattering detector, a differential refractometer or a UV detector. As used herein, the term “molecular weight” means the weight average molecular weight.

Various adhesion control agents (“ACAs”) can be used in the interlayers of the present disclosure to control the adhesion of the interlayer sheet to glass. In various embodiments of interlayers of the present disclosure, the interlayer can comprise about 0.003 to about 0.15 parts ACAs per 100 parts resin; about 0.01 to about 0.10 parts ACAs per 100 parts resin; and about 0.01 to about 0.04 parts ACAs per 100 parts resin. Such ACAs, include, but are not limited to, the ACAs disclosed in U.S. Pat. No. 5,728,472 (the entire disclosure of which is incorporated herein by reference), sodium acetate, potassium acetate, magnesium bis(2-ethyl butyrate), and/or magnesium bis(2-ethylhexanoate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers, among other additives known to those of ordinary skill in the art.

In various embodiments, the plasticizer may be selected from high refractive index plasticizers, a mixture of two or more high refractive index plasticizers, or a mixture of a conventional plasticizer and one or more high refractive index plasticizer(s).

As used herein, plasticizer having a refractive index of about 1.450 or less is referred to as a “conventional plasticizer”. Conventional plasticizers include, but are not limited to, triethylene glycol di-(2-ethylhexanoate) (“3GEH”), triethylene glycol di-(2-ethylbutyrate), triethylene glycol diheptanoate, tetraethylene glycol diheptanoate, tetraethylene glycol di-(2-ethylhexanoate), dihexyl adipate, dioctyl adipate, hexyl cyclohexyladipate, diisononyl adipate, heptylnonyl adipate, di(butoxyethyl) adipate, and bis(2-(2-butoxyethoxy)ethyl) adipate, dibutyl sebacate, dioctyl sebacate, and mixtures thereof. These plasticizers have refractive indices of about 1.442 to about 1.449. In comparison, PVB resin has a refractive index of approximately 1.485 to 1.495. In interlayers manufactured for various properties and applications, 3GEH (refractive index=1.442) is one of the most common plasticizers present.

In various embodiments, one or more high refractive index plasticizer(s) may be used. In embodiments, the high refractive index plasticizer(s) is selected such that the refractive index of the plasticizer is at least about 1.460, or greater than about 1.460, or greater than about 1.470, or greater than about 1.480, or greater than about 1.490, or greater than about 1.500, or greater than 1.510, or greater than 1.520, for both the core and/or skin layers. As used herein, a “high refractive index plasticizer” is a plasticizer having a refractive index of at least about 1.460. In some embodiments, the high refractive index plasticizer(s) is used in conjunction with a conventional plasticizer, and in some embodiments, if included, the conventional plasticizer is triethylene glycol di-(2-ethylhexanoate) (“3GEH”), and the refractive index of the plasticizer mixture is at least 1.460. As used herein, the refractive index of a plasticizer or a resin used in the entirety of this disclosure is either measured in accordance with ASTM D542 at a wavelength of 589 nm and 25° C. or as reported in literature in accordance with the ASTM D542.

Examples of plasticizers having a high refractive index that may be used include, but are not limited to, polyadipates (RI of about 1.460 to about 1.485); epoxides (RI of about 1.460 to about 1.480); phthalates and terephthalates (RI of about 1.480 to about 1.540); benzoates (RI of about 1.480 to about 1.550); and other specialty plasticizers (RI of about 1.490 to about 1.520). Specific examples of suitable high refractive index plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, bis-phenol A bis(2-ethylhexaonate), ethoxylated nonylphenol, nonylphenyl tetraethylene glycol, dioctyl phthalate, diisononyl phthalate, di-2-ethylhexyl terephthalate, mixtures of benzoic acid esters of dipropylene glycol and diethylene glycol, and mixtures thereof.

The total plasticizer content in the interlayer can be from 0 to 120 phr, or greater than 0 phr, or greater than 5 phr, or greater than 10 phr, or greater than 15 phr, or greater than 20 phr, or greater than 25 phr, or greater than 30 phr and/or 120 phr or less, or 115 phr or less, or 110 phr or less, or 105 phr or less, or 100 phr or less, or 95 phr or less, or 90 phr or less, or 85 phr or less, or 80 phr or less, or 75 phr or less, or 70 phr or less, or within the range of 10 to 100 phr, or 20 to 80 phr, or 30 to 70 phr. In various embodiments of interlayers of the present disclosure, the interlayer comprises greater than 5 phr, about 5 to about 120 phr, about 10 to about 90 phr, about 20 to about 70 phr, about 30 to about 60 phr, or less than 120 phr, or less than 90 phr, or less than 60 phr, or less than 40 phr, or less than 30 phr total plasticizer. While the total plasticizer content is indicated above, the plasticizer content in the skin layer(s) or core layer(s) can be different from the total plasticizer content. In addition, the skin layer(s) and core layer(s) can have different plasticizer types and plasticizer contents, in the ranges previously discussed, as each respective layer's plasticizer content at the equilibrium state is determined by the layer's respective residual hydroxyl contents, as disclosed in U.S. Pat. No. 7,510,771 (the entire disclosure of which is incorporated herein by reference). For example, at equilibrium the interlayer could comprise two skin layers, each with 30 phr plasticizer, and a core layer with 65 phr plasticizer, for a total plasticizer amount for the interlayer of about 45.4 phr when the combined skin layer thickness equals that of the core layer. For thicker or thinner skin layers, the total plasticizer amount for the interlayer would change accordingly. As used herein, when the plasticizer content of the interlayer is given, the plasticizer content is determined with reference to the phr of the plasticizer in the mix or melt that was used to produce the interlayer.

The amount of plasticizer in the interlayer can be adjusted to affect the glass transition temperature (T_{g}) and the final acoustic performance of the interlayer. The glass transition temperature (T_{g}) is the temperature that marks the transition from the glassy state of the interlayer to the rubbery state. In general, higher amounts of plasticizer loading will result in lower T_{g}. Conventional, previously utilized interlayers generally have had a T_{g} in the range of about-10 to 25° C. for acoustic (noise reducing) interlayers, and up to about 45° C. for hurricane and aircraft (stiffer or structural) interlayer applications. The glass transition temperature (T_{g}) can be determined by dynamical mechanical thermal analysis (DMTA) in shear mode. The DMTA measures the storage (elastic) modulus (G′) in Pascals, loss (viscous) modulus (G″) in Pascals, tan delta (=G″/G′) of the specimen as a function of temperature at a given frequency, and temperature sweep rate. A frequency of 1 Hz and temperature sweep rate of 3° C./min were used herein. The T_{g} is then determined by the position of the tan delta peak on the temperature scale in ° C. and the tan delta peak value is referred as tan delta or peak tan delta. As used herein, “tan delta”, “peak tan delta”, “tan δ” and “peak tan δ” may be used interchangeably.

An interlayer's glass transition temperature (T_{g}) is also correlated with the stiffness of the interlayer, and in general, the higher the glass transition temperature, the stiffer the interlayer. Generally, an interlayer with a glass transition temperature of 30° C. or higher increases laminated glass mechanical strength and torsional rigidity. A soft layer or interlayer (generally characterized by a layer or interlayer with a glass transition temperature of lower than 20° C.), on the other hand, contributes to the sound dampening effect (i.e., the acoustic characteristics). The interlayers of the present disclosure may have glass transition temperatures of about 26° C. or greater, or about 37° C. or greater for the stiffer layer(s), and about 20° C. or less, or 15° C. or less, or 10° C. or less, or about 5° C. or less, or 0° C. or less, or about −5° C. or less, or about −10° C. or less for the soft layer(s), although other glass transition temperatures are possible depending on the desired performance and properties.

In some embodiments, the multilayered interlayers of the present disclosure combine these two advantageous properties (i.e., strength and acoustic) by utilizing harder or stiffer skin layers laminated with a softer core layer (e.g., stiff//soft//stiff). In various embodiments, the multilayered interlayers generally comprise stiffer layer(s) comprising poly(vinyl acetal) resin(s) with a glass transition temperature of about 26° C. to about 60° C., about 38° C. to 48° C., about 26° C. or greater, about 30° C. or greater, or about 37° C. or greater, and softer layer(s) of about 20° C. or less, about 10° C. or less, or about 5° C. or less, or about 0° C. or less, or about −5° C. or less, or about −10° C. or less.

The final interlayer, whether formed from extrusion or co-extrusion or by lamination of multiple layers, generally has a random rough surface topography as it is formed through melt fractures of polymer melt as it exits the extrusion die and may additionally be embossed over the random rough surface on one or both sides (e.g., the skin layers) by any method of embossment known to one of ordinary skill in the art.

While all methods for the production of polymer interlayer sheets known to one of ordinary skill in the art are contemplated as possible methods for producing the polymer interlayer sheets described herein, this application will focus on polymer interlayer sheets produced through the extrusion and co-extrusion processes. The final multiple layer glass panel laminates of the present invention are formed using lamination processes known in the art.

Generally, the thickness, or gauge, of the polymer interlayer sheet will be in a range from about 10 mils to 100 mils (about 0.25 mm to about 2.54 mm), about 15 mils to 60 mils (about 0.38 mm to about 1.52 mm), about 20 mils to about 50 mils (about 0.51 to 1.27 mm), and about 15 mils to about 35 mils (about 0.38 to about 0.89 mm). In various embodiments, each of the layers, such as the skin and core layers, of the multilayer interlayer may have a thickness of about 1 mil to 99 mils (about 0.025 to 2.51 mm), about 1 mil to 59 mils (about 0.025 to 1.50 mm), 1 mil to about 29 mils (about 0.025 to 0.74 mm), or about 2 mils to about 28 mils (about 0.05 to 0.71 mm), although other thicknesses may be selected depending on the desired performance and properties.

Although many of the embodiments described below refer to the polymer resin as being PVB, it would be understood by one of ordinary skill in the art that the polymer may be any polymer suitable for use in a multiple layer panel. Typical polymers include, but are not limited to, polyvinyl acetals (PVA) (such as poly(vinyl butyral) (PVB) or poly(vinyl isobutyral), an isomer of poly(vinyl butyral) and also referred as PVisoB, aliphatic polyurethane (PU), poly(ethylene-co-vinyl acetate) (EVA), polyvinylchloride (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and its ionomers, derived from any of the foregoing possible thermoplastic resins, combinations of the foregoing, and the like. PVB and its isomer polyvinyl isobutyral, polyvinyl chloride, ionomers, and polyurethane are suitable polymers generally for interlayers; PVB (including its isomer PVisoB) is particularly suitable.

Examples of exemplary multilayer interlayer constructs include, but are not limited to, PVB//PVisoB//PVB, where the PVisoB layer comprises two or more resins having different residual hydroxyl and/or residual acetate contents or different polymer compositions; PVC//PVB//PVC, PU//PVB//PU, Ionomer//PVB//Ionomer, Ionomer//PU//Ionomer, Ionomer//EVA//Ionomer, where the core layer PVB (including PVisoB), PU or EVA can comprise a single resin having one glass transitions or two or more resins having different glass transitions. Alternatively, the skin and core layers may all be PVB using the same or different starting resins, having the same or different residual hydroxyl and/or residual acetate contents, and the same or different plasticizers. Other combinations of resins and polymers will be apparent to those skilled in the art.

While generally referred to as poly(vinyl acetal) or poly(vinyl butyral), any of the poly(vinyl acetal) resins can include residues of any suitable aldehyde, such as isobutyraldehyde, as previously discussed. In some embodiments, one or more poly(vinyl acetal) resin can include residues of at least one C₁ to C₁₀ aldehyde, or at least one C₄ to C₈ aldehyde. Examples of suitable C₄ to C₈ aldehydes can include, but are not limited to, n-butyraldehyde, isobutyraldehyde, 2-methylvaleraldehyde, n-hexyl aldehyde, 2-ethylhexyl aldehyde, n-octyl aldehyde, and combinations thereof. At least one of the first and second poly(vinyl acetal) resins can include at least about 20, at least about 30, at least about 40, at least about 50, at least about 60, or at least about 70 weight percent of residues of at least one C₄ to C₈ aldehyde, based on the total weight of aldehyde residues of the resin, and/or can include not more than about 90, not more than about 85, not more than about 80, not more than about 75, not more than about 70, or not more than about 65 weight percent of at least one C₄ to C₈ aldehyde, or in the range of from about 20 to about 90, about 30 to about 80, or about 40 to about 70 weight percent of at least one C₄ to C₈ aldehyde. The C₄ to C₈ aldehyde may be selected from the group listed above, or it can be selected from the group consisting of n-butyraldehyde, isobutyraldehyde, 2-ethylhexyl aldehyde, and combinations thereof.

In various embodiments, one or more poly(vinyl acetal) resin may be a poly(vinyl butyral) (PVB) resin. In other embodiments, one or more poly(vinyl acetal) resin can be a poly(vinyl butyral) resin that mainly comprises residues of n-butyraldehyde, and may, for example, include not more than about 50, not more than about 40, not more than about 30, not more than about 20, not more than about 10, not more than about 5, or not more than about 2 weight percent of residues of an aldehyde other than butyraldehyde, based on the total weight of all aldehyde residues of the resin.

As used herein, a multiple layer panel can comprise a single substrate, such as glass, acrylic, or polycarbonate (or other rigid substrate) with a polymer interlayer sheet disposed thereon, and most commonly, with a polymer film further disposed over the polymer interlayer. The combination of polymer interlayer sheet and polymer film is commonly referred to in the art as a bilayer. A typical multiple layer panel with a bilayer construct is: (glass)//(polymer interlayer sheet)//(polymer film), where the polymer interlayer sheet can comprise multiple interlayers, as noted above. The polymer film supplies a smooth, thin, rigid substrate that affords better optical character than that usually obtained with a polymer interlayer sheet alone and functions as a performance enhancing layer. Polymer films differ from polymer interlayer sheets, as used herein, in that polymer films do not themselves provide the necessary penetration resistance and glass retention properties, but rather provide performance improvements or functional attributes, such as infrared absorption characteristics. Poly(ethylene terephthalate) (“PET”) is the most commonly used polymer film. Generally, as used herein, a polymer film is thinner than a polymer sheet, such as from about 0.001 to 0.2 mm thick, although other thicknesses may be used. The polymer film may be referred to as a functional film or layer, especially when it provides a particular performance improvement or function to the interlayer.

The interlayers of the present disclosure will most commonly be utilized in multiple layer panels comprising two substrates, such as a pair of glass sheets (or other rigid materials, such as polycarbonate or acrylic, known in the art), with the interlayers disposed between the two substrates. An example of such a construct would be: (glass)//(polymer interlayer sheet)//(glass), where the polymer interlayer sheet can comprise multilayered interlayers, as noted above. These examples of multiple layer panels are in no way meant to be limiting, as one of ordinary skill in the art would readily recognize that numerous constructs other than those described above could be made with the interlayers of the present disclosure.

The typical glass lamination process comprises the following steps: (1) assembly of the two substrates (e.g., glass) and interlayer (as further described herein); (2) heating the assembly via an IR radiant or convective means for a short period; (3) passing the assembly into a pressure nip roll for the first deairing; (4) heating the assembly a second time to about 60° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperatures between about 125° C. and 150° C. and pressures between about 180 psig and 200 psig for about 30 to 90 minutes. The actual steps, as well as the times and temperatures, may vary as necessary, as known by one skilled in the art.

Other means for use in de-airing of the interlayer-glass interfaces (steps 2 to 5) known in the art and that are commercially practiced include vacuum bag and vacuum ring processes in which a vacuum is utilized to remove the air.

The coefficient of friction measures the friction between the interlayer and a substrate. The friction is a complex phenomenon influenced by multiple factors, such as roughness, embossing patterns, stiffness, surface energy, surface treatment or coating, chemical compatibility, pressure, and environmental temperature. Lower surface energy materials typically exhibit less friction, while higher surface energy material will have a higher COF.

Coefficient of friction (COF) was measured according to ASTM D1894. Samples were measured in two ways. The COF was measured by testing material to material (interlayer to interlayer) as well as interlayer to a metal sled, as described in D1894. The samples were allowed to condition for 40 hours before testing at 23° C. and 50% relative humidity. The test speed used was 150 mm/min. The samples were cut to 5 inches wide×10 inches long for the interlayer to sled COF testing, and cut to 5 inches wide×10 inches long and tested against a 2.5 inches×2.5 inches interlayer on the sled for the interlayer to interlayer COF testing.

Warm shrinkage was measured as follows: interlayer sheet samples were cut out from the roll immediately after extrusion. The individual sample was marked using a template (10 cm length in the machine direction), and then each individual sample was placed on a piece of cardboard. The samples on the carboard were placed on the rack in an oven (temperature pre-set at 54° C.). The samples were then removed from the oven after 10 minutes and placed on the benchtop to allow them to cool down to room temperature for a minimum of 5 minutes. The sample length in the machine direction was measured using a calibrated ruler before and after the oven treatment at 54° C. The shrinkage was calculated as the percentage of the length change in the machine direction relative to the original length prior to the oven treatment.

Surface roughness (Rz and Rsm) was measured on the interlayer samples using a Mahr M1 500 Perthometer. Each sample was measured at three locations, and three surface traces were run on each measurement location in the machine and cross machine direction. The reported surface Rz and Rsm values are the averaged values from both directions at the top and bottom sides of the sheet from the three locations.

The damping loss factor (η) was measured by Mechanical Impedance Measurement (MIM) as described in ISO 16940. For the multilayer interlayers used in the examples below, the damping loss factor (MIM), was measured in the laboratory on a small laminate sample or bar. The samples were 25 mm wide by 300 mm long (about 1″×12″) and having a pair of 2.3 mm clear glass substrates that were prepared by a standard lamination process. The samples were excited at the center point of the bar by a vibration shaker (Bruel and Kjær). An impedance head (Brüel and Kjær) was used to measure the force to excite the bar to vibrate and the velocity of the vibration and the resultant transfer function is recorded on a National Instrument data acquisition and analysis system. The loss factor at the first vibration mode is calculated using the half-power method. The laminates are conditioned at room temperature for 3 months after lamination, and conditioned at the testing temperature (e.g., 20° C.) for at least 4 hours before conducting the MIM test.

In embodiments, the laminated glazing may be a window for a vehicle, such as a side lite.

In embodiments, the interlayer in the laminated glazing may include an interlayer wherein the first poly(vinyl acetal) resin and the third poly(vinyl acetal) resin are the same. In embodiments, the difference between the first residual hydroxyl content and the second residual hydroxyl content is at least 2.0 (2.5, 3.0, 3.5, 4.0, 4.5, 5.0, 5.5, 6.0 or more) weight percent. In embodiments, the difference between the first residual acetate content and the second residual acetate content is at least 2.0 (2.5, 3.0, 3.5, 4.0, 4.5, 5.0, 5.5, 6.0 or more) weight percent.

In embodiments, the first and third plasticizers are the same. In other embodiments, the second plasticizer is the same as at least one of the first plasticizer or the third plasticizer. In embodiments, at least one plasticizer may be a mixture of two or more plasticizers. In embodiments, at least one plasticizer may be a high refractive index plasticizer as defined herein.

In embodiments, the interlayer has is colored (i.e., not clear and less visual transmittance, such as less than 75%), such as grey (light grey, dark grey or any grey color). In other embodiments, the interlayer comprises an IR absorber in at least one layer. In embodiments, the interlayer may be colored and may comprise an IR absorber in at least one layer.

In embodiments, the interlayer further comprises at least one non-poly(vinyl acetal) layer. In embodiments, the interlayer comprises a tie layer between layers. In embodiments, the interlayer comprises a functional film, layer or sheet. In embodiments, the interlayer comprises a least one non-poly(vinyl acetal) layer and a functional film, layer or sheet.

In embodiments, a multiple layer glass panel comprising the interlayer has a damping loss factor (η) at 20° C. measured according to ISO 16940 of at least 0.20 (0.21, 0.22, 0.23, 0.24, 0.25, 0.26, 0.27, 0.28, 0.29, 0.30 or more).

Any of the features described herein may be combined with any other features. For example, the laminated glazing or windshield may include an interlayer that has a non-poly(vinyl acetal) layer and/or a functional film, layer or sheet, and the interlayer may be colored, or the interlayer may comprise an IR absorber in at least one layer and also be colored, or the interlayer may be such that the first poly(vinyl acetal) resin and the third poly(vinyl acetal) resin are the same, and also have at least a first and second residual hydroxyl content wherein the difference between the first residual hydroxyl and/or acetate content and the second residual hydroxyl and/or acetate content is at least 2.0 (2.5, 3.0, 3.5, 4.0, 4.5, 5.0, 5.5, 6.0 or more) weight percent. Other combinations of features are also included and contemplated.

### EXAMPLES

Exemplary multilayer interlayers (DE-1 to DE-6) and a comparative interlayer (CE-1) were produced by mixing and melt-extruding 100 parts poly(vinyl butyral) resins and various amounts of plasticizer, and other common additives (as described above), as shown in Table 1. For the disclosed examples, a mixture of 3GEH and DPG-dibenzoate plasticizers were used, and the amount (%) of 3GEH in the mixture is shown in Table 1. The comparative (control) example used only 3GEH plasticizer. The core layer thickness of all the samples (DE-1 to DE-6 and CE-1) is about 4.5 mil. The total thickness of each interlayer is shown in Table 1.

The four PVB resins used to make the layers include:
PVB1: PVB resin having about 23.8% by weight residual PVOH content.
PVB2: PVB resin having about 18.5% by weight residual PVOH content.
PVB3: PVB resin having about 9% by weight residual PVOH content.
PVB4: PVB resin having about 10.5% by weight residual PVOH content.

The multilayer interlayers produced were then tested and used to construct various laminates as shown in the Tables and as described more fully below. The improvement in acoustic properties, such as damping loss factor (η), as well as the improvement in COF and warm shrinkage can be most readily appreciated by a comparison of interlayers and laminates containing multilayer (trilayer) interlayers. As shown and discussed below, these Examples demonstrate that the disclosed interlayers have an improved (lower) coefficient of friction and warm shrinking while also having excellent acoustic damping properties when certain changes are made to the multilayer interlayers.

Table 1 shows the compositions and the MIM damping loss factor of the disclosed and comparative multilayer interlayer sheets.

TABLE 1

| | | | Plasticizer | | | | |
|---|---|---|---|---|---|---|---|
| | | First | content | | Second | | |
| | 3GEH % | and | (phr) in | | layer | | |
| | in the | third | the first | Second | plasticizer | Total | MIM |
| | plasticizer | layer | and third | layer | content | thickness | Damping |
| Examples | mixture | resin | layer | resin | (phr) | (mil) | Loss factor |
| DE-1 | 40 | PVB1 | 39.3 | PVB3 | 80 | 32 | 0.32 |
| DE-2 | 65 | PVB1 | 27.3 | PVB3 | 75 | 30 | 0.29 |
| DE-3 | 65 | PVB1 | 27.3 | PVB3 | 75 | 30 | 0.29 |
| DE-4 | 65 | PVB1 | 27.3 | PVB3 | 75 | 30 | 0.29 |
| DE-5 | 65 | PVB1 | 27.3 | PVB3 | 75 | 30 | 0.29 |
| DE-6 | 65 | PVB1 | 27.3 | PVB3 | 75 | 30 | 0.29 |
| CE-1 | 100 | PVB2 | 38 | PVB4 | 75 | 33 | 0.26 |

Disclosed multilayer interlayers (DE-1 to DE-6) and a comparative multilayer interlayer (CE-1) as shown in Table 1 were tested for COF by testing both the interlayer to interlayer and the interlayer to the metal sled, according to ASTM D1984 (previously described). Both a channel pattern (non-random or regular embossing pattern) and a random rough surface pattern were tested for the disclosed interlayers. A comparative interlayer having a channel pattern or regular surface pattern was also tested. Results are shown in Table 2 below.

TABLE 2

| | Interlayer to | | Interlayer to | | | | | Skin |
|---|---|---|---|---|---|---|---|---|
| | metal sled | | Interlayer | | Surface | Surface | Surface | layer |
| | Static | Dynamic | Static | Dynamic | Rz | Rsm | pattern | Tg |
| Sample | COF | COF | COF | COF | μm | μm | type | (° C.) |
| DE-1 | 0.632 | 0.232 | 0.856 | 0.272 | 41.2 | 310.2 | Channel | 39 |
| DE-2 | 0.531 | 0.226 | 0.703 | 0.261 | 45.5 | 314.6 | pattern | 43 |
| DE-3 | 0.689 | 0.233 | 0.922 | 0.283 | 36.1 | 313.4 | | |
| DE-4 | 0.671 | 0.266 | 0.742 | 0.273 | 24.9 | 307.7 | | |
| DE-5 | 0.497 | 0.295 | 0.739 | 0.432 | 45.4 | 619.5 | Random | 43 |
| DE-6 | 0.454 | 0.306 | 0.709 | 0.365 | 38.5 | 560.4 | rough | |
| DE-7 | 0.539 | 0.309 | 0.705 | 0.296 | 25.0 | 506.7 | pattern | |
| CE-1 | 2.587 | 1.611 | 1.856 | 0.417 | 38.1 | 283.2 | Channel | 30.2 |
| | | | | | | | pattern | |

As shown in Table 2, the disclosed interlayers DE-1 to DE-6 have a significantly lower COF (both static and dynamic) when tested against both an interlayer and a metal sled compared to the comparative interlayer.

Two samples (DE-1 and CE-1) were also tested for warm shrinkage according to the warm shrinkage test method previously described. The samples were also reviewed for lamination processability to determine how they handled during processing. Processing included handling the samples (interlayer blanks) cut from a roll using suction cups to place an interlayer blank on a piece of glass, followed by placement of a second piece of glass to form a pre-assembly. The interlayer blanks were not allowed to relax; instead they were used immediately after being cut from the roll. The pre-assembly was then deaired and autoclaved, and the final assembly was assessed to determine if there was any shortage of interlayer due to shrink. Results and observations on processability and handling are shown in Table 3 below.

TABLE 3

| | Warm | |
|---|---|---|
| | shrinkage | |
| Sample | (%) | Lamination processability |
| DE-1 | 2.7 | No stickiness between interlayer |
| | | blanks when the interlayer blanks |
| | | were picked up by the suction cups. |
| | | No short interlayer at the laminate |
| | | edges after the lamination using the |
| | | blanks immediately following cut from |
| | | the roll. |
| CE-1 | 6.8 | About 20% of blanks had an issue |
| | | being picked up by the suction cups |
| | | and were difficult to handle. |
| | | After lamination, short interlayer at |
| | | the laminate edge was observed |
| | | when using the interlayer blanks |
| | | immediately following cut from the |
| | | roll. |

As shown by Table 3, the disclosed sample, DE-1, has significantly improved processability and lower shrink than the comparative example, CE-1, which had a significantly higher COF and warm shrinkage than DE-1. While the disclosed example had no stickiness between interlayer blanks when placed in a stack of blanks (as previously described) and then picked up by the suction cups, about 20% of the comparative interlayer blanks had an issue during handling and moving and stuck to each other (when being moved or lifted from the stacks). For the comparative interlayer, there was also an issue with the interlayer not being long enough (short interlayer) when the interlayer blanks were used immediately after being cut from the roll while the disclosed interlayers, which had a much lower warm shrinkage value, did not exhibit the short interlayer issue.

It was found that high damping acoustic interlayers having a certain combination of additional features, such as a higher glass transition temperature in the outer or skin layers in combination with lower warm shrinkage and lower static coefficient of friction have improved handling and processability and allow for use of an automated assembly process for making a multiple layer panel.

In conclusion, the interlayers and laminated glazings, such as side lites and windshields for automobiles, comprising multilayered interlayers according to the invention have better (less) warm shrinkage values, reduced COF and enhanced damping compared to other multilayer interlayers and laminated glazings comprising the interlayer. Other advantages will be readily apparent to those skilled in the art.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, an interlayer can be formed comprising poly(vinyl butyral) having a residual hydroxyl content in any of the ranges given in addition to comprising a plasticizers in any of the ranges given to form many permutations that are within the scope of the present disclosure, but that would be cumbersome to list. Further, ranges provided for a genus or a category, such as phthalates or benzoates, can also be applied to species within the genus or members of the category, such as dioctyl terephthalate, unless otherwise noted.

1. A polymer interlayer comprising at least one layer, wherein the interlayer has a warm shrinkage of less than about 4.0%, a static coefficient of friction (COF) of less than 1.50 when measured according to ASTM D1894 with an interlayer-to-interlayer configuration, and wherein a laminated glazing comprising the interlayer has a damping loss factor (η) of at least 0.20 when measured at 20° C. according to ISO 16940.

2. The interlayer of claim 1, wherein the interlayer has a static coefficient of friction (COF) of less than 2.00 when measured according to ASTM D1894 with an interlayer to metal sled configuration.

3. The interlayer of claim 1, wherein the interlayer has a dynamic coefficient of friction (COF) of less than 0.50 when measured according to ASTM D1894 with the interlayer to the interlayer configuration.

4. The interlayer of claim 1, wherein the interlayer has a dynamic coefficient of friction (COF) of less than 1.00 when measured according to ASTM D1894 with the interlayer to metal sled configuration.

5. The interlayer of claim 1, wherein the interlayer is a multilayer interlayer.

6. The interlayer of claim 1, wherein the interlayer is a multilayer interlayer, and the multilayer interlayer comprises:
a first layer comprising a first poly(vinyl acetal) resin having a first residual hydroxyl content and a first residual acetate content, and a first plasticizer, wherein the first layer has a glass transition temperature (T_{g}) greater than 37° C.;
a second layer comprising a second poly(vinyl acetal) resin having a second residual hydroxyl content, a second residual acetate content, and a second plasticizer, wherein the second layer has a glass transition temperature (T_{g}) less than 20° C.; and
a third layer comprising a third poly(vinyl acetal) resin having a third residual hydroxyl content, a third residual acetate content, and a third plasticizer, wherein the third layer has a glass transition temperature (T_{g}) greater than 37° C.,
wherein the second layer is between the first layer and the third layer.

7. The interlayer of claim 1, wherein the interlayer is colored and has % T less than about 75%.

8. The interlayer of claim 7, wherein the interlayer is grey.

9. The interlayer of claim 1, wherein the interlayer comprises an IR absorber.

10. The interlayer of claim 9, wherein the interlayer further comprises a non-poly(vinyl acetal) layer.

11. The interlayer of claim 10, wherein the interlayer further comprises a functional film, layer or sheet.

12. The interlayer of claim 6, wherein the difference between the first residual hydroxyl content and the second residual hydroxyl content is at least 2.0 weight percent.

13. The interlayer of claim 6, wherein the difference between the first residual acetate content and the second residual acetate content is at least 2.0 weight percent.

14. A laminated glazing comprising a first rigid substrate, the interlayer of claim 13, and a second rigid substrate, wherein the interlayer is between the first rigid substrate and the second rigid substrate, and wherein the laminated glazing is a side lite, sunroof or other window in a vehicle.

15. A process for making a multiple layer glass panel, the process comprising the steps of:
providing a first rigid substrate to an assembly fixture,
providing the polymer interlayer of claim 1,
placing the interlayer blank on the first rigid substrate using a transport device, providing a second rigid substrate, and
placing the second rigid substrate on the interlayer blank, thereby forming a pre-assembly.

16. The process of claim 15, wherein further comprising the step of moving the pre-assembly to a de-airing process.

17. The process of claim 16, wherein the de-airing process comprises a nip roll, vacuum bag, or vacuum ring.

18. The process of claim 16, further comprising moving the pre-assembly to an autoclave to form a final multilayer panel.

19. The process of claim 18, wherein the multilayer panel is a side lite, sunroof or other window in a vehicle.

20. A multiple layer panel comprising:
a first glass substrate;
a polymer interlayer; and
a second rigid substrate;
wherein the interlayer has a warm shrinkage of less than about 4.0%, a static coefficient of friction (COF) of less than 1.50 when measured according to ASTM D1894 with the interlayer to interlayer configuration, and wherein the multiple layer panel has a damping loss factor (η) of at least 0.20 when measured at 20° C. according to ISO 16940.
